(19) United States
(12) Patent Application Publication
(10) Pub. No.: US 2009/0242426 A1
(43) Pub. Date: Oct. 1, 2009

(54) Gas Sensor

(75) Inventors: Muammer Kilinc, Regensburg (DE); Bertrand Lemire, Schierling (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens VDO Automotive AG, Regensburg (DE)

(21) Appl. No.: 11/922,799

(22) PCT Filed: Jun. 13, 2006
(86) PCT No.: PCT/EP2006/063119

§ 371 Date: Dec. 21, 2007

(30) Foreign Application Priority Data
Jun. 23, 2005 (DE) 10 2005 029 556.8

(51) Int. Cl. G01N 27/403; G01N 27/26

(52) U.S. Cl. 205/781; 205/780.5; 205/785.5; 205/775; 204/431

(57) ABSTRACT

Presented is a gas sensor and method for detecting the quantity of a measurement gas contained in a gas mixture. The sensor includes a prechamber, a first pump device disposed in the prechamber configured to set the partial pressure of a free gas component of a detection gas to a predetermined value, and a measuring chamber separated from the prechamber by a diffusion barrier. The measuring chamber includes a detection device configured to determine the concentration of the detection gas. The sensor further includes an inlet chamber separated from the prechamber by a diffusion barrier, a second pump device disposed in the inlet chamber configured to set the partial pressure of the free gas component of the detection gas to a predetermined value, and a third pump device disposed in the measuring chamber and configured to set the partial pressure of the free gas component to a predetermined value.

The invention relates to a gas sensor for detecting the quantity of a measurement gas contained in a gas mixture, comprising:
a prechamber, in which a pump device is formed, by means of which the partial pressure of a free gas component of a detection gas can be set to a predetermined value,
a measuring chamber, which is separated from the prechamber by a diffusion barrier and in which a further pump device is formed, by means of which the partial pressure of the free gas component can be set to a predetermined value below the value of the partial pressure prevailing in the prechamber and comprising
a detection device, which, in order to determine the concentration of detection gas, determines a measure of the gas component quantity liberated from the detection gas in the measuring chamber.

A gas sensor of this type is known from KATO, N; KURACHI, H; HAMADA, Y: Thick Film ZrO2 NOx Sensor for the Measurement of Low NOx Concentration. In: SAE TECHNICAL PAPER SERIES 980170. The known gas sensor comprises a substrate based on zirconium oxide, a prechamber and a measuring chamber being formed in said substrate. An external air duct with a reference electrode arrangement therein is furthermore situated in the substrate. The exhaust gas emitted by an internal combustion engine passes through a first diffusion barrier into the prechamber. A control device detects the Nernst voltage between the reference electrode in the external air duct and a measuring electrode assigned to the prechamber and controls a pump cell for oxygen in such a way that the measured Nernst voltage is set to a predetermined value. The known gas sensor involves regulating the Nernst voltage in the prechamber to 300 mV. This corresponds to an oxygen concentration of 1 ppm. At this oxygen concentration, the free oxygen is almost completely removed in the prechamber. The oxygen bonded in the nitrogen oxides is not liberated, however.

The prechamber is followed by a measuring chamber, which is separated from the prechamber by a further diffusion barrier. A further control device assigned to the measuring chamber detects the Nernst voltage between the reference electrode in the external air duct and a measuring electrode assigned to the measuring chamber and regulates a pump cell assigned to the measuring chamber in such a way that the Nernst voltage is set to a predetermined value. The known gas sensor involves regulating the Nernst voltage in the measuring chamber to a value of 400 mV. This corresponds to an oxygen concentration of 0.01 ppm.

Furthermore, a detection device is provided in the measuring chamber, said detection device being formed by the reference electrode in the external air duct and a detection electrode. The detection electrode is produced on the basis of rhodium. The detection electrode therefore acts as a reducing catalyst that brings about a decomposition of the nitrogen oxides. The oxygen formed by the decomposition of nitrogen oxides is pumped away by the detection device, the pump current required for this being a measure of the concentration of nitrogen oxides in the measuring cell.

The known gas sensor is suitable in particular for the detection of nitrogen oxides in the context of exhaust gas after treatment. By way of example, the nitrogen oxide emission from diesel engines is intended to be reduced further by means of suitable exhaust gas after treatment systems. The so-called selective catalytic reduction (=SCR) technology is provided, inter alia, for this purpose, which involves injecting a urea solution into a catalyst. The ammonia produced after the decomposition of urea adsorbs on the catalyst. The nitrogen oxides from the exhaust gas react with the ammonia adsorbed on the catalyst to form nitrogen and water.

In order, then, to be able to precisely regulate the injection of the urea solution, an ammonia sensor which is as precise as possible and which if possible has no cross-sensitivity to further exhaust gas components is required.

Proceeding from this prior art, therefore, the invention is based on the object of providing a selective gas sensor which is as precise as possible for a measurement gas whose concentration cannot be detected by conventional gas sensors which are sensitive to a detection gas.

This object is achieved by means of a gas sensor comprising the features of the independent claim. Advantageous configurations and developments are specified in claims dependent on said independent claim.

The gas sensor for detecting the quantity of a measurement gas contained in a gas mixture has, like conventional gas sensors for detecting a detection gas, a prechamber and a measuring chamber including the pump and detection devices required for detecting the detection gas. In addition, the gas sensor for detecting the measurement gas is provided with an inlet chamber, which is arranged upstream of the prechamber in the flow direction and is separated from the prechamber by a further diffusion barrier. A pump device is formed in the inlet chamber, by means of which pump device the partial pressure of the free gas component of the detection gas can be set to a predetermined value below the value of the partial pressure prevailing in the prechamber. Furthermore, in the prechamber of the gas sensor, the partial pressure of the gas component is set to a value at which the measurement gas can be converted into the detection gas by reaction with the free gas component. In the gas sensor, the free gas component is largely removed in the inlet chamber. As a result, the detection gas decomposes in the measuring chamber. The quantity of the detection gas produced in the prechamber by reaction between the free gas component and the measurement gas therefore essentially corresponds to the quantity of the measurement gas that entered into the inlet chamber. The detection gas contained in the prechamber can then be detected in a conventional manner, the quantity of detected detection gas being a measure of the quantity of the measurement gas to be detected.

By switching off the pump device in the inlet chamber, the gas sensor for the measurement gas can be converted into a gas sensor for the detection gas.

The gas component is preferably an oxidizing gas, in particular oxygen. Accordingly, the detection gas involves gaseous oxides, in particular nitrogen oxides, for which sensor arrangements are known which, by means of an inlet chamber being disposed upstream, can be reconfigured as a precise and selective gas sensor for ammonia.

The detection device preferably comprises a catalyst for the reduction of the detection gas. The detection device furthermore comprises a voltage source, which keeps the voltage between a detection electrode provided with the catalyst and a pump electrode with a predetermined value, and also a current measuring unit, which measures the current required for this purpose. Detection devices of this type are available in particular for the detection of gaseous oxides.

The inlet chamber, the prechamber and the measuring chamber preferably each comprise a measuring unit which measures the voltage between a reference electrode exposed to ambient air and a respective electrode assigned to the inlet chamber, the prechamber and the measuring chamber. The measuring units assigned to the inlet chamber, the prechamber and the measuring chamber each act on current sources which control the current through pump cells. By varying the current flowing through the pump cells, the current sources keep the voltages detected by the voltage measuring units at predetermined values. The pump cells comprise a respective electrode assigned to the inlet chamber, the prechamber and the measuring chamber and also a common pump electrode exposed to exhaust gases, a solid electrolyte, in particular based on zirconium oxide, being situated between said electrodes.

In one preferred embodiment of the gas sensor, the current source assigned to the inlet chamber adjusts the voltage measured by the voltage measuring unit to a value of between 600 and 800 mV. The current source assigned to the prechamber furthermore keeps the voltage detected by the associated voltage measuring unit to a value of between 100 and 200 mV. Finally, the current source assigned to the measuring chamber adjusts the voltage detected by the associated measuring unit preferably to a value of between 350 and 450 mV.

Further properties and advantages of the invention will become apparent from the description below, in which exemplary embodiments of the invention are explained in detail with reference to the accompanying drawing, in which:

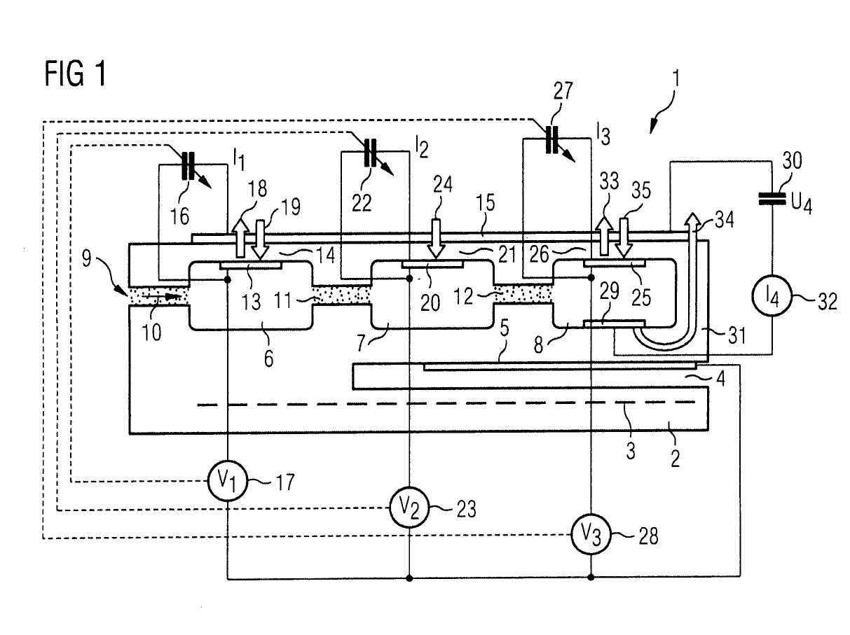

FIG. 1 shows a cross section through a gas sensor for detecting ammonia; and

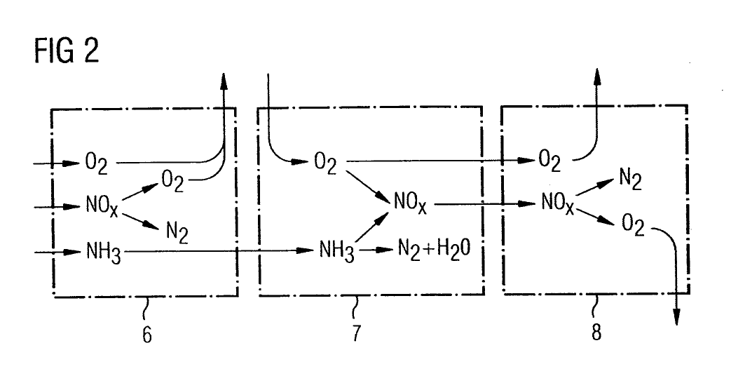

FIG. 2 shows a diagram illustrating the gas flow in the gas sensor from FIG. 1.

FIG. 1 shows a gas sensor 1 comprising a substrate 2, which is produced on the basis of yttrium-oxide-doped zirconium dioxide with cubic lattice structure. A resistance heating system 3 produced on the basis of platinum is provided in the substrate 2, said resistance heating system heating the substrate 2 to a temperature of approximately 800° C. An external air duct 4 with a reference electrode 5 situated therein is furthermore formed in the substrate 2. An inlet chamber 6, a prechamber 7 and a measuring chamber 8 are furthermore formed in the substrate 2. An exhaust gas to be analyzed can enter into the inlet chamber 6 through an inlet opening 9 and a diffusion barrier 10. It passes from said inlet chamber into the prechamber 7 via a further diffusion barrier 11. Finally, the prechamber 7 is separated from the measuring chamber 8 by a diffusion barrier 12.

In the inlet chamber 6, the nitrogen oxides from the exhaust gas are reduced to nitrogen at a first electrode 13. The oxygen thereby obtained is removed, together with the oxygen already present in the exhaust gas, from the inlet chamber 6 by means of a pump cell 14. The pump cell 14 comprises a further pump electrode 15 besides the first electrode 13. The pump electrode 15 is exposed to the exhaust gas.

The pump cell 14 is operated with a current I₁ from a current source 16, which sets the current I, such that a voltage U₁ measured by a voltmeter 17 remains at a predetermined value. The voltage U₁ is set to a value of between 600 and 800 mV, preferably to a value in the region of 700 mV. A Nernst voltage dimensioned in this way sets an air ratio corresponding to λ<1 in the inlet chamber 6. Accordingly, an outflow 18 of oxygen generally takes place in the pump cell 14 if λ>1 holds true in the exhaust gas. Occasionally, however, an inflow 19 of oxygen can also be brought about by the pump cell 14 if λ<<1 in the exhaust gas.

In the exemplary embodiment illustrated in the drawing, a single electrode, namely the first electrode 13, which is preferably produced on the basis of a noble metal such as platinum, for example, is used for the reduction of the nitrogen oxides and for setting the oxygen content in the inlet chamber.

The gas mixture contained in the inlet chamber 6 flows through the diffusion barrier 11 into the prechamber 7, where a second electrode 20 together with the pump electrode 15 forms a second pump cell 21. A current source 22 supplies the pump cell 21 with a current I₂, which is set by the current source 22 such that a lean air ratio corresponding to λ>1 is set in the prechamber 7. For this purpose, the current is regulated by the current source 22 in such a way that a voltage U₂—measured by a voltmeter 23—between the second electrode 20 and the reference electrode 5 is set to a predetermined value within the range of between 100 and 200 mV. The Nernst voltage U₂ between the second electrode 20 and the reference electrode 5 is preferably set to a value in the region of 150 mV, however.

A lean air ratio, corresponding to λ>1, thus prevails in the prechamber 7. As a result, the reducing exhaust gas components such as carbon monoxide and hydrocarbons are oxidized to form carbon dioxide and water and ammonia is oxidized to form nitrogen oxides. Accordingly, an inflow 24 of oxygen generally takes place through the pump cell 21.

In the measuring chamber 8, the oxygen diffusing through the diffusion barrier 12 passes to a third electrode 25, which together with the pump electrode 15 forms a third pump cell 26. A current source 27 is connected to the pump cell 26 and regulates the current through the pump cell 26 in such a way that a voltage U₃—measured by a voltmeter 28—between the third electrode 25 and the reference electrode 5 remains at a predetermined value within the range of 350 and 450 mV. The Nernst voltage U₃ in the measuring chamber 8 is preferably kept at a value in the region of 400 mV. As a result, the air ratio with regard to oxygen is set approximately to stoichiometry.

On account of a suitable doping of the third electrode 25 produced on the basis of a noble metal such as platinum, no reduction of the nitrogen oxides takes place at the electrode 25. Rather, the nitrogen oxides are reduced to nitrogen and oxygen at a measuring electrode 29. The oxygen produced at the measuring electrode 29 is removed from the measuring chamber 8 with the aid of a current source 30. The pump voltage U₄ required for this is applied between the measuring electrode 29 and the pump electrode 15. The pump voltage U₄ is likewise set to a value within the range of between 350 and 450 mV, preferably to a value of approximately 400 mV.

The measuring electrode 29 together with the pump electrode 15 thus forms a measuring cell 31. The current I₄ through the measuring cell 31 is detected by an ammeter 32. The magnitude of the current I₄ is a direct measure of the ammonia concentration in the exhaust gas.

In general, therefore, from the measuring chamber 8 an outflow 33 takes place through the pump cell 26 and a further outflow 34 takes place through the measuring cell 31. Occasionally, however, an inflow 35 of oxygen can also occur through the pump cell 26.

The measuring electrode 29 is preferably produced on the basis of a noble metal such as platinum.

FIG. 2 shows an overview of the gas flow in the gas sensor from FIG. 1. In the inlet chamber 6, the nitrogen oxides that entered through the inlet opening 9 are removed from the exhaust gas. This is achieved by the reduction of the nitrogen oxides to oxygen and nitrogen. The oxygen gas component bonded in the nitrogen oxides is then removed together with the free oxygen.

In the prechamber 7, ammonia is at least partly converted into nitrogen oxides and these nitrogen oxides are detected in the measuring chamber 8. The ammonia measurement is therefore taken back to a nitrogen oxide measurement. For the measurement of the concentration of nitrogen oxides, tried and tested devices and methods are available which permit nitrogen oxides to be measured with high selectivity and great accuracy even when used in series.

It should be pointed out that no serious cross-sensitivity to nitrogen oxides is to be expected since gaseous nitrogen is produced both in the inlet chamber 6 and in the prechamber 7 and the measuring chamber 8, such that it is not necessarily the case that the nitrogen originating from the reduction of the nitrogen oxides in the inlet chamber 6 flows into the prechamber 7 and is oxidized there to form nitrogen oxides. If nitrogen does flow from the inlet chamber 6 into the prechamber 7 and is oxidized there to form nitrogen oxide, this becomes apparent in an offset of the current I₄ which can be calibrated out.

The gas sensor 1 described here can optionally be used as an ammonia sensor or as a nitrogen oxide sensor. The gas sensor 1 operates as a nitrogen oxide sensor in particular when the regulation of the oxygen concentration in the inlet chamber 6 is deactivated by the current source 16 being disconnected from the pump cell 14.

The principle of a gas sensor described here can fundamentally be applied to further hydrogen-containing gases which can be oxidized to form gaseous oxides. By way of example, a gas sensor of this type can fundamentally also be used for measuring the concentration of hydrogen sulfides or hydrocarbons.

Furthermore, the principle can also be applied to gases which do not contain hydrogen and which can be oxidized by addition of a further free gas component, where the oxidized gas can be dissociated by reduction in the measuring chamber.

Furthermore, it should be pointed out that further measurement principles known to the person skilled in the art can also be applied instead of the amperometric measurement principle used in the measuring chamber 8.

1-14. (canceled)

15. A method for detecting the quantity of a measurement gas contained in a gas mixture with the aid of a gas sensor, comprising:
setting the partial pressure of a free gas component of a detection gas in a prechamber of the gas sensor to a predetermined value by a first pump device, the measurement gas being at least partly converted into the detection gas by reaction with the free gas component in the prechamber;
determining, by a detection device disposed in a measuring chamber of the gas sensor, the concentration of the detection gas by determining a measure of the quantity of a gas component that is liberated from the detection gas in the measuring chamber, the measuring chamber being separated from the prechamber by a first diffusion barrier;
setting the partial pressure of the free gas component of the detection gas in an inlet chamber of the gas sensor to a predetermined value below the value of the partial pressure prevailing in the prechamber by a second pump device, the inlet chamber being separated from the prechamber by a second diffusion barrier; and
setting the partial pressure of the free gas component in the measuring chamber to a predetermined value below the value of the partial pressure prevailing in the prechamber by a third pump device.

16. The method as claimed in claim 15, further comprising setting the partial pressure of the gas component in the inlet chamber to a predetermined value below the value of the partial pressure prevailing in the measuring chamber by the second pump device.

17. The method as claimed in claim 15, wherein the gas component is an oxidizing gas.

18. The method as claimed in claim 18, wherein the gas component is oxygen.

19. The method as claimed in claim 15, wherein the detection gas comprises gaseous oxides.

20. The method as claimed in claim 19, wherein the detection gas comprises nitrogen oxides.

21. The method as claimed in claim 15, wherein the measurement gas is a hydrogen-containing gas.

22. The method as claimed in claim 21, wherein the measurement gas is ammonia.

23. The method as claimed in claim 15, wherein the detection gas is reduced by the detection device using a catalyst.

24. The method as claimed in claims 15, wherein the detection device disposed in the measuring cell comprises a measuring electrode, a pump electrode, a current source, and an ammeter detecting the current intensity of the pump current flowing through the measuring cell as a measure of the concentration of detection gas in the measuring chamber.

25. The method as claimed in claim 15, wherein the first, second, and third pump devices each comprise a voltmeter for detecting the Nernst voltage between a reference electrode exposed to external air and a respective electrode assigned to the inlet, prechamber, and measuring chambers, and a current source for varying the current flowing through a respective pump cell to keep the Nernst voltage detected by the associated voltmeters at a predetermined value.

26. The method as claimed in claim 25, wherein the Nernst voltage assigned to the inlet chamber is kept at a value within the range of between 600 and 800 mV in the pump cell of the inlet chamber.

27. The method as claimed in claim 25, wherein the Nernst voltage assigned to the prechamber is kept at a value within the range of between 100 and 200 mV in the pump cell of the prechamber.

28. The method as claimed in claim 25, wherein the Nernst voltage assigned to the measuring chamber is kept at a value within the range of 350 and 450 mV in the pump cell of the measuring chamber.

29. The method as claimed in claim 15, wherein the detection gas passes from the prechamber into the measuring chamber through the first diffusion barrier separating the prechamber and the measuring chamber.

30. The method as claimed in claim 15, wherein the measurement gas passes from the inlet chamber into the prechamber through the second diffusion barrier separating the inlet chamber and the prechamber.

31. A gas sensor for detecting the quantity of a measurement gas contained in a gas mixture, comprising:
a prechamber in which the measurement gas can be at least partly converted into a detection gas by reaction with a free gas component;
a first pump device configured to set the partial pressure of the free gas component of the detection gas in the prechamber to a predetermined value;
a measuring chamber separated from the prechamber by a first diffusion barrier, the measuring chamber comprising a detection device configured to determine the concentration of the detection gas by determining a measure of the quantity of the gas component that is liberated from the detection gas in the measuring chamber;
an inlet chamber separated from the prechamber by a second diffusion barrier;
a second pump device configured to set the partial pressure of the free gas component of the detection gas in the inlet chamber to a predetermined value below the value of the partial pressure prevailing in the prechamber; and
a third pump device configured to set the partial pressure of the free gas component in the measuring chamber to a predetermined value below the value of the partial pressure prevailing in the prechamber.

32. The method as claimed in claim 31, wherein the second pump device is further configured to set the partial pressure of the gas component in the inlet chamber to a predetermined value that is below the value of the partial pressure prevailing in the measuring chamber.

33. The method as claimed in claim 31, wherein the gas component is an oxidizing gas.

34. The method as claimed in claim 33, wherein the gas component is oxygen.

35. The method as claimed in claim 31, wherein the detection gas comprises gaseous oxides.

36. The method as claimed in claim 35, wherein the detection gas comprises nitrogen oxides.

37. The gas sensor as claimed in claim 31, wherein the measurement gas is a hydrogen-containing gas.

38. The gas sensor as claimed in claim 37, wherein the measurement gas is ammonia.

39. The gas sensor as claimed in claim 31, wherein the detection device comprises a catalyst for reducing the detection gas.

40. The method as claimed in claim 31, wherein the detection device comprises a measuring cell comprising a measuring electrode, a pump electrode, a current source, and an ammeter detecting the current intensity of the pump current flowing through the measuring cell as a measure of the concentration of detection gas in the measuring chamber.

41. The gas sensor as claimed in claim 31, wherein the first, second, and third pump devices each comprise a voltmeter for detecting the Nernst voltage between a reference electrode exposed to external air and a respective electrode assigned to the inlet, prechamber, and measuring chambers, and a current source which keeps the Nernst voltage detected by the associated voltmeters at a predetermined value by varying the current flowing through a respective pump cell.

42. The method as claimed in claim 41, wherein the pump cell of the inlet chamber keeps the Nernst voltage assigned to the inlet chamber at a value within the range of between 600 and 800 mV.

43. The gas sensor as claimed in claim 41, wherein the pump cell of the prechamber keeps the Nernst voltage assigned to the prechamber at a value within the range of between 100 and 200 mV.

44. The gas sensor as claimed in claim 41, wherein the pump cell of the measuring chamber keeps the Nernst voltage assigned to the measuring chamber at a value within the range of 350 and 450 mV.

45. The gas sensor as claimed in claim 31, wherein the measuring chamber is disposed downstream of the prechamber in the flow direction of the detection gas.

46. The gas sensor as claimed in claim 31, wherein the inlet chamber is disposed upstream of the prechamber in the flow direction of the free gas component.
